(19) United States
(12) Patent Application Publication
(10) Pub. No.: US 2026/0122383 A1
(43) Pub. Date: Apr. 30, 2026

(54) REMOTELY CONFIGURABLE VARIABLE RATIO COUPLER DEVICES AND NETWORKS INCORPORATING THE SAME

(71) Applicant: CORNING RESEARCH & DEVELOPMENT CORPORATION, Corning, NY (US)

(72) Inventors: Oberon Denaci Deichmann, Painted Post, NY (US); William James Miller, Horseheads, NY (US); Eric Stephan ten Have, Berlin (DE); Peter Gerard Wigley, Corning, NY (US)

(21) Appl. No.: 18/928,676

(22) Filed: Oct. 28, 2024

(51) Int. Cl. H04Q 11/00; G02B 6/293; H04J 14/02

(52) U.S. Cl. CPC H04Q 11/0067; G02B 6/2938; G02B 6/29395; H04J 14/02; H04Q 2011/0079

(57) ABSTRACT

An optical network includes a plurality of variable ratio coupler (VRC) devices. Each VRC device includes an input, a main output, and a branch output, a VRC, an actuator operable to control the VRC to vary a split ratio of the VRC, a wavelength division multiplex (WDM) filter positioned within the branch output and includes a common port, a transmit port and a reflect port. The WDM filter is operable to pass a control wavelength at the transmit port and a filtered optical signal at the reflect port, and a controller operable to receive an optical control signal from the WDM filter and control the actuator to manipulate the VRC to a desired split ratio. The input, the main output and the branch output of the plurality of VRC devices are coupled such that the plurality of VRC devices is arranged in a branching network having a plurality of levels.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G, and the like. As optical fiber extends deeper into communication networks there exists a need for building more complex and flexible fiber optic networks in a quick and easy manner.

However, installation of a fiber optic network may be costly, particularly in rural areas where the population is much less dense than in urban or suburban areas.

A fiber optic network, such as a passive optical network (PON), may be built before the number and location of paying subscribers is known. Initially, there may be many more homes passed than homes connected and this situation may persist, particularly in low-density areas. Nevertheless, as the system is being built, it should be made sure that the homes passed can be converted into homes connected upon demand. For many system designs, this requires that expensive hardware be installed on day-one to provide such potential coverage to all or an acceptable fraction of homes passed. For these reasons, rural areas may be underserved with respect to broadband internet.

Consequently, there exists an unresolved need for fiber optic network configurations that have reduced up-front costs that also enable subscribers to be added on demand.

### SUMMARY

In one embodiment, an optical network includes a plurality of variable ratio coupler (VRC) devices. Each VRC device includes an input, a main output, and a branch output, a VRC coupled to the input, the main output and the branch output, an actuator operable to control the VRC to vary a split ratio of the VRC, a wavelength division multiplex (WDM) filter positioned within the branch output and includes a common port, a transmit port and a reflect port. The WDM filter operable to receive an optical signal at the common port and further operable to pass an optical control signal having a control wavelength at the transmit port and a filtered optical signal at the reflect port. The VRC device also includes a controller operable to receive an optical control signal having the control wavelength from the WDM filter and control the actuator to manipulate the VRC to have a split ratio based upon the optical control signal. The input, the main output and the branch output of the plurality of VRC devices are coupled such that the plurality of VRC devices is arranged in a branching network having a plurality of levels.

In another embodiment, a variable ratio coupler (VRC) device includes a housing, a VRC within the housing that includes an input, a main output and a branch output, an actuator within the housing operable to control the VRC to vary a split ratio of the VRC, at least one wavelength division multiplex (WDM) filter within the housing includes common port, a transmit port and a reflect port. The at least one WDM filter operable to receive an optical signal at the common port and further operable to pass an optical control signal having a control wavelength at the transmit port and a filtered optical signal at the reflect port. The VRC device also includes a controller within the housing operable to receive the optical control signal having the control wavelength provided by the at least one WDM filter and control the actuator to manipulate the VRC to a have a split ratio based upon the optical control signal.

In another embodiment, an optical network includes a plurality of variable ratio coupler (VRC) devices and a plurality of splitters. Each splitter includes a splitter input and two splitter outputs. The splitter splits an input optical signal. Each VRC device includes an output, a main input, and an alternate input, a VRC coupled to the output, the main input and the alternate input, an actuator operable to control the VRC to vary a split ratio of the VRC, a wavelength division multiplex (WDM) filter positioned within the output and includes a common port, a transmit port and a reflect port. The WDM filter operable to receive an optical signal at the common port and further operable to pass an optical control signal having a control wavelength at the transmit port and a filtered optical signal at the reflect port. Each VRC device also includes a controller operable to receive the optical control signal having the control wavelength from the WDM filter and control the actuator to manipulate the VRC to a split ratio corresponding with the optical control signal. The optical network is a branching optical network having a plurality of levels. The plurality of VRCs is within an individual level of the plurality of levels. Each VRC device is coupled to an individual splitter output of the two splitter outputs of a preceding splitter at the main input and an alternate route optical fiber at the alternate input.

In another embodiment, an optical network includes a plurality of variable ratio coupler (VRC) devices and a plurality of optical network units (ONU). Each VRC device includes an input, a main output, and a branch output, a VRC coupled to the input, the main output and the branch output, an actuator operable to control the VRC to vary a split ratio of the VRC, a controller operable to receive a control signal and control the actuator to manipulate the VRC to a split ratio corresponding with the control signal. The plurality of VRC devices is coupled such that the plurality of VRC devices is arranged in a branching network having a plurality of levels. The plurality of ONUs is at a lowest level of the plurality of levels. Each ONU of the plurality of ONUs includes an ONU VRC such that an ONU input of the ONU VRC is coupled to downstream components of the optical network toward a subscriber, a main ONU output of the ONU VRC is coupled to a preceding VRC device in the optical network, and a branch ONU output of the ONU VRC is coupled to an alternate communication path.

In another embodiment, a variable ratio coupler (VRC) device includes a housing, a VRC within the housing that includes an input, a main output and a branch output, an actuator within the housing operable to control the VRC to vary a split ratio of the VRC, a wireless communication receiver operable to receive a wireless control signal providing a split ratio, and a controller operable to receive a signal corresponding to the wireless control signal from the wireless communication receiver and control the actuator to manipulate the VRC to the split ratio corresponding with the wireless control signal.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a variable ratio coupler (VRC) according to one or more embodiments described and illustrated herein.

FIG. 2 illustrates a VRC device capable of being remotely controlled by an optical control signal according to one or more embodiments described and illustrated herein.

FIG. 3 illustrates a chain of VRC devices in an asymmetric distributed split network according to one or more embodiments described and illustrated herein.

FIG. 4 illustrates a branching network of a plurality of VRC devices.

FIG. 5 illustrates a branching network of a plurality of VRC devices having four control wavelengths according to one or more embodiments described and illustrated herein.

FIG. 6 illustrates another VRC device capable of being remotely controlled by an optical control signal according to one or more embodiments described and illustrated herein.

FIG. 7 illustrates a branching network comprising a plurality of splitters and a plurality of VRC devices according to one or more embodiments described and illustrated herein.

FIG. 8 illustrates another VRC device capable of being remotely controlled by an optical control signal according to one or more embodiments described and illustrated herein.

FIG. 9 illustrates a static branching network comprising a plurality of splitters.

FIG. 10A illustrates a direct link between an optical line termination (OLT) and an optical network unit (ONU).

FIG. 10B illustrates an ONU having a VRC device providing an alternate line between an OLT and an ONU according to one or more embodiments described and illustrated herein.

FIG. 10C illustrates an ONU having a VRC device providing an alternate line between an OLT and the ONU with a node therebetween according to one or more embodiments described and illustrated herein.

FIG. 10D illustrates an ONU having a VRC device and an OLT having a VRC device providing an alternate line between the OLT and the ONU according to one or more embodiments described and illustrated herein.

FIG. 11 illustrates a branching network comprising a plurality of VRC devices that are controlled by a control system according to one or more embodiments described and illustrated herein.

FIG. 12 illustrates a VRC device capable of being controlled by a wireless control signal according to one or more embodiments described and illustrated herein.

FIG. 13 illustrates a network comprising a plurality of VRC devices capable of being controlled by wireless control signals according to one or more embodiments described and illustrated herein.

### DETAILED DESCRIPTION

Embodiments of the present disclosure are directed to variable ratio coupler (VRC) devices and networks incorporating the same that provide for remote control of split ratios, and dynamic adjustment of a network for optimal performance and to mitigate network issues, such as those issues due to natural disasters. Thus, embodiments of the present disclosure allow performance optimization of the network, the delivery of premium services under varying network conditions to privileged customers, and fault recovery. The VRC devices described herein may be remotely controlled by optical control signals or by wireless control signals. The optical control signals may be provided by wavelength division multiplexing or time division multiplexing, or by means of envelope modulation of the optical communication signal.

In some embodiments, a control system that monitors the state of the network can control the settings of all VRC devices in the network. Thus, network performance can be optimized for specific target uses based on the current status of data demand, network conditions, and the like.

VRCs have been used in passive optical networks (PONs) with a distributed tap architecture (DTA). In DTA PONs, each network access point (NAP) has an asymmetric 1×2 tap coupler where the low tap ratio leg connects to a 1×N splitter which serves up to N local subscribers, one to each splitter output; the other coupler leg connects to the remaining subscribers further downstream of the optical line termination (OLT). With fixed tap couplers, each NAP needs a specific tap ratio depending on its position in the DTA system, which necessitates multiple NAP stock-keeping units (SKUs).

Moreover, to keep SKU count low, the set of available tap ratios represents a compromise with optimum optical power efficiency, which would require a customized tap ratio at every NAP, determined by the optical path loss between the OLT and the optical network unit (ONU). By using a VRC in place of the fixed tap coupler, a single NAP SKU can be used. If the number of settings of the VRC is high enough, the optical power efficiency can also be improved by exploiting finer-grained control of the optical path loss.

Thus, the VRC was initially designed as a drop-in replacement for a fixed tap with a means to set or reset the tap ratio, i.e., a control interface at the tap for single, or at the most, infrequent use. While the taps allow network optimization in principle, e.g., when users are added or removed from the network, network reconfiguration requires intervention by an operator, which makes reconfiguration slow. Therefore, the network is quasi-static. Furthermore, replacement of a single upstream tap to allow network optimization may impact downstream power for subscriber ONUs, which may require replacement of multiple taps to optimize downstream tap ratios, further requiring intervention by an operator at multiple locations in the network.

Future flexible PON networks work with bitrates of up to 100 Gbit/s and will allow for adaptation of the transmission method to match the users' channel conditions and optimize throughput. This is done through ONU grouping, flexible modulation format, and flexible forward error correction (FEC) code rate.

As described in more detail below, embodiments of the present disclosure provide VRC devices capable of being remotely controlled to further increase the flexibility of the network and allow an improved performance through additional optimization options.

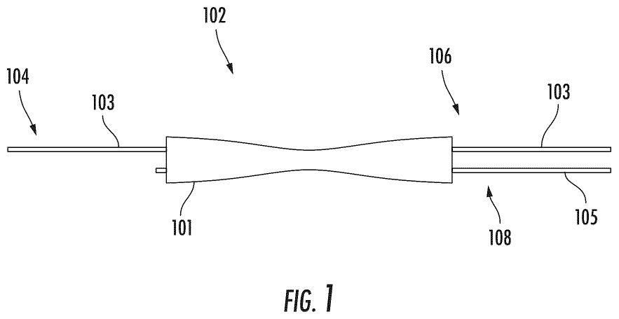

Referring now to FIG. 1, an example VRC 102 is schematically illustrated. Generally, the VRC 102 comprises two optical fibers within a glass tube 101. A first optical fiber 103 forms both an input 104 and a main output 106, while a second optical fiber 105, which is terminated at the input side of the glass tube 101, forms a branch output 108. Through heating and pulling, a waist is formed at the center of the structure, such that light can couple between the two optical fibers, forming an optical directional coupler. After manufacture, by bending the VRC 102, the amount of optical power transferred from the first optical fiber 103 to the second optical fiber 105 can be controlled. Thus, a split ratio between the two outputs of the VRC 102 can be controlled. When the amount of optical power transferred from the first optical fiber 103 to the second optical fiber 105 at the branch output 108 is x, the optical power of the optical signal remaining in the input optical fiber at the main output 106 is approximately 1−x as the VRC 102 has low excess optical loss.

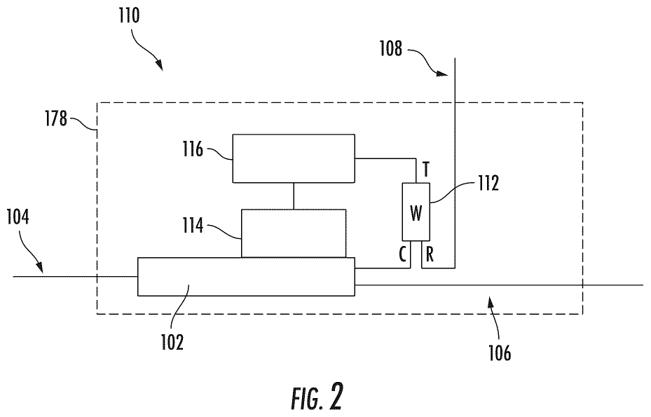

Through a mechanism, such as an actuator, the state of the VRC 102 may be changed by mechanical manipulation to change the amount of optical power transferred from the first optical fiber 103 to the second optical fiber 105. The split ratio may therefore be changed on demand from 0% to 100%. Referring now to FIG. 2, an example VRC device 110 including a VRC 102 within a housing 178 is illustrated. The 110 further includes an actuator 114 that applies mechanical force onto the VRC 102 to bend the VRC 102 and achieve a desired split ratio for the VRC device 110 for the optical signals within the branch output 108 and the main output 106. The actuator 114 may be any mechanical device operable to receive a control signal and deflect the VRC 102 by the desired amount. As a non-limiting example, the actuator 114 may be a stepper motor.

The VRC device 110 further includes a controller 116 that is operable to provide a control signal to the actuator 114 such that the actuator 114 moves to deflect the VCR so that a desired split ratio is achieved. In embodiments of the present disclosure, the controller 116 is remotely controlled so that a technician is not required to be physically present to adjust the actuator or otherwise manually set the split ratio of the VRC device 110. Although the controller 116 could have an electronic interface to receive an electric input voltage signal, this would require a power source such as a battery or capacitor and a separate conductive wire to be run from a remote location such as a central office equipped with a master controller, and thus an additional electrical cable would have to be deployed in parallel to the optical cable for transmission of control signals from a central office.

In the example VRC device 110 of FIG. 2, the controller receives an optical control signal that is derived from the optical signal provided by the master controller from the central office and injected into the VRC device 110 to control the actuator 114. The VRC device 110 further includes a wavelength division multiplex (WDM) filter 112 that separates a single wavelength from the optical signal at the branch output 108 split off from the main output 106. A portion of the optical signal provided to the WDM filter 112 at a common port C having a control wavelength matching the filter wavelength of the WDM filter 112 is transmitted by the WDM filter 112 through a transmit port T. All other wavelengths of the optical signal are reflected by the WDM filter 112 and exit through the reflect port R.

In a PON network, multiple wavelengths are in use to connect the optical line terminals at the central office with the ONUs at the customer's premises to transmit data in both directions (i.e. duplex optical transmission). Typically, more optical channels (i.e., separately defined wavelengths) exist than required for the connection of all customers on a PON network. In embodiments of the present disclosure, one or more of the channels (i.e., wavelengths outside the band used for data transmission in a particular PON network, a so-called out-of-band channel) are used to communicatively connect the master controller at the central office to all VRC devices 110 in a branching network.

A channel of the optical signal matching the wavelength of the WDM filter 112 defines an optical control signal that is filtered by the WDM filter 112 and provided to the controller 116. The controller 116 interprets the optical control signal having a control wavelength to decode a desired split ratio. The controller then sends one or more electrical control signals to the actuator 114 so the actuator moves to deflect the VRC 102 and achieve the desired split ratio between the main output 106 and the branch output 108.

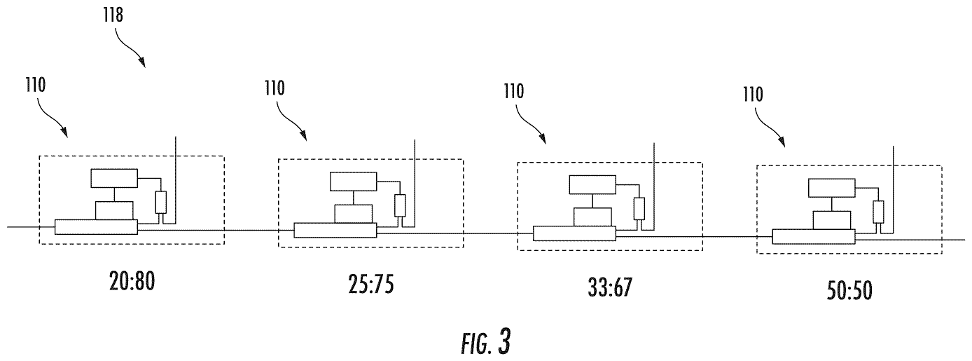

FIG. 3 illustrates a chain of VRC devices 110 in an asymmetric distributed split network 118. In this linear network 118, each branch of the network 118 receives the same amount of power with the split ratios as shown. As the required optical power may vary at each of the branch points, the split ratios can be adjusted at the VRCs 102 to optimize total network throughput or throughput to selected customers.

Having one fixed VRC control channel is only possible in a linear network similar to the one shown in FIG. 3 as the WDM filter 112 will remove the wavelength from that branch of the network, i.e., any other VRC devices 110 communicating on the same channel would not be addressable.

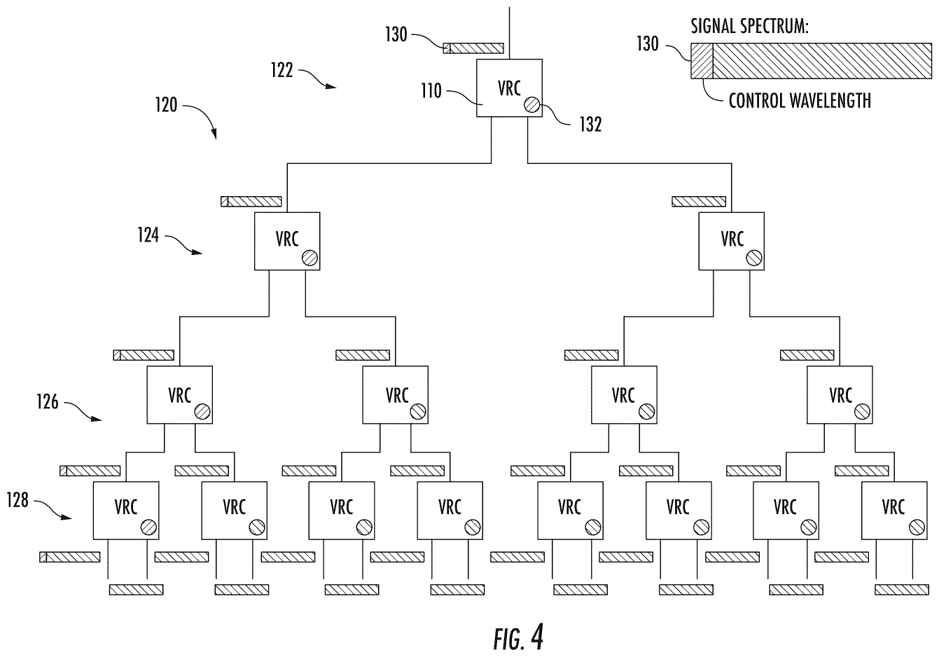

FIG. 4 illustrates this issue in a branching network 120. The network 120 includes a plurality of levels of connected VRC devices 110. The number of VRC devices 110 increase toward the lower levels of the network 120. In the illustrated embodiment, a first level 122 has one VRC device 110, a second level 124 has two VRC devices 110, a third level 126 has four VRC devices 110, and a fourth level 128 has eight VRC devices 110. The signal spectrum 130 of the optical signal provides for one control wavelength (i.e., one control channel) and many data communication channels. Each VRC device 110 has an expected control wavelength 132 that matches the control wavelength of the signal spectrum.

The control signal can only propagate through a single branch of the network because it is filtered from one of the outputs of every VRC device 110. The dark circle on a VRC device 110 indicates that the VRC device 110 can be actively addressed by an optical control signal having the control wavelength. The white circle on a VRC device 110 indicates that the VRC device is unaddressable by way of an optical control signal having the control wavelength. Such a solution is undesirable because not all of the VRC devices 110 in the network 120 are addressable.

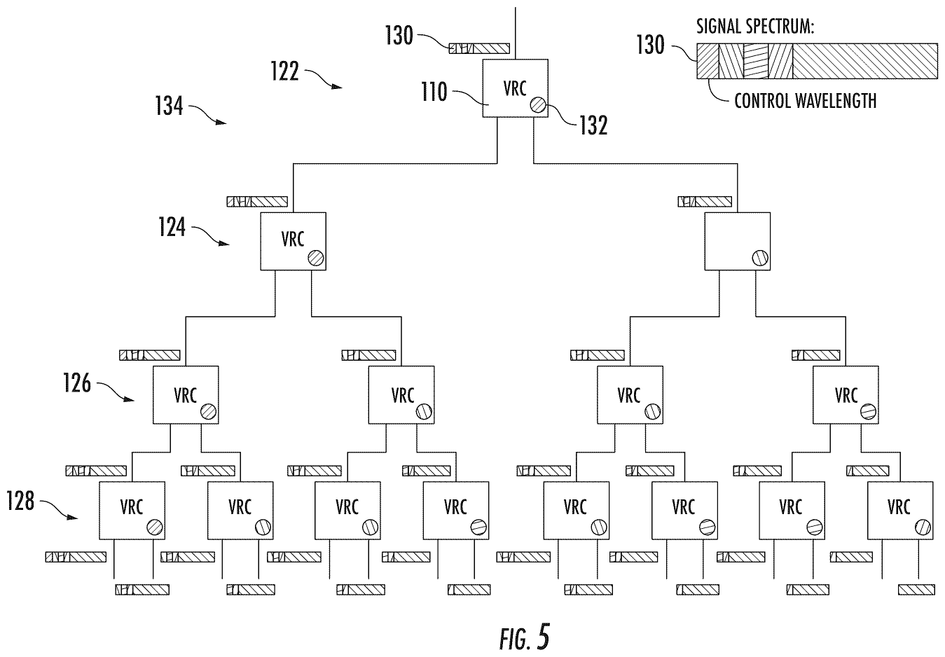

In some embodiments of the present disclosure, the number of control wavelengths is increased within the signal spectrum 130, as shown in FIG. 5. In the illustrated embodiment, four control wavelengths are utilized; however, it should be understood that more or fewer control wavelengths may be used. The minimum number of wavelengths to address all splitters in such a network (assuming that all levels are fully populated) corresponds to the number of levels of the network, which is four in the embodiment illustrated in FIG. 5. The number of VRC devices 110 is greater than the number of control wavelengths. With the correct arrangement of expected control wavelengths 132, all of the VRC devices VRC device 110 within the network 134 may be addressed by the master controller at the central office. The circle at the lower right of each VRC device 110 indicates the expected control wavelength 132 for the particular VRC device 110 (i.e., WL 1, WL 2, WL 3, and WL 4). The incoming signal spectrum 130 is shown at the input of each VRC device 110. As shown by FIG. 5, with multiple control channels, every VRC device 110 in the network is addressable. As described above, when a VRC device 110 receives an optical control signal having its expected control wavelength 132, the WDM filter 112 filters the optical control signal out of the optical signal and passes it to the controller 116. The controller 116 interprets the optical control signal and generates a control signal that is provided to the actuator 114 so that the actuator 114 deflects the VRC 102 so the VRC device 110 has a split ratio in accordance with the optical control signal.

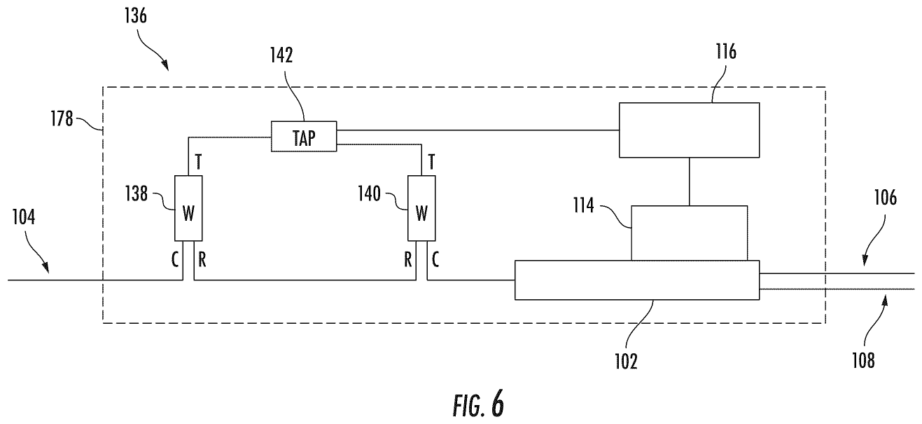

FIG. 6 illustrates another embodiment for allowing every VRC device 110 in a branching optical network to be addressed by an optical control signal having a control wavelength. More particularly, FIG. 6 illustrates a VRC device 136 having two WDM filters in the form of a first WDM filter 138 and a second WDM filter 140, as well as a splitter tap 142. Similar to the VRC device 110 shown in FIG. 2, the VRC device 110 of FIG. 6 includes a VRC 102, an actuator 114, a controller 116, an input 104, main output 106, and a branch output 108.

The first WDM filter 138, the second WDM filter 140 and the splitter tap 142 are operable to provide a portion of an optical control signal to the controller 116 and reinject the remainder of the optical control signal into the input 104 of the VRC 102 for use by downstream VRC devices 136 in the branching optical network. The first WDM filter 138, the second WDM filter 140 and the splitter tap 142 are positioned at the input side of the VRC 102. The common port C of the first WDM filter 138 is coupled to the input 104 of the VRC device 136, the transmit port T of the first WDM filter 138 is coupled to the input of the splitter tap 142, and the reflect port R of the first WDM filter 138 is coupled to the reflect port R of the second WDM filter 140. One output of the splitter tap 142 is coupled to the controller 116 while the other output of the splitter tap 142 is coupled to the transmit port T of the second WDM filter 140. The common port C of the second WDM filter 140 is coupled to the input of the VRC 102.

An optical signal having an optical control signal with a control wavelength as well as data signals of other wavelengths is provided to the VRC device 136 at the input 104. The first WDM filter 138 receives the optical signal at the common port C, passes the optical control signal having the control wavelength to the input port of the splitter tap 142 through the transmit port T. The remaining wavelengths of the optical signal (i.e., the filtered optical signal) are reflected through the reflect port R of the first WDM filter 138 and passed to the reflect port R of the second WDM filter 140. The filtered optical signal is reflected out of the second WDM filter 140 at the common port C and provided to the input of the VRC 102.

The tap 142 splits the incoming optical control signal by some ratio, and provides a portion of the optical control signal to the controller out of a first output (e.g., without limitation, 1%, 2%, 3%, 4%, or 5%) so that the controller 116 may interpret the data of the optical control signal and control the actuator 114 accordingly. A second portion of the optical control signal is provided out of the second output to the transmit port T of the second WDM filter 140 where it is reinjected into the filtered optical signal and exits the common port C of the second WDM filter 140. In this manner, a portion of the optical control signal is available to address downstream VRC devices 136 in a branching optical network.

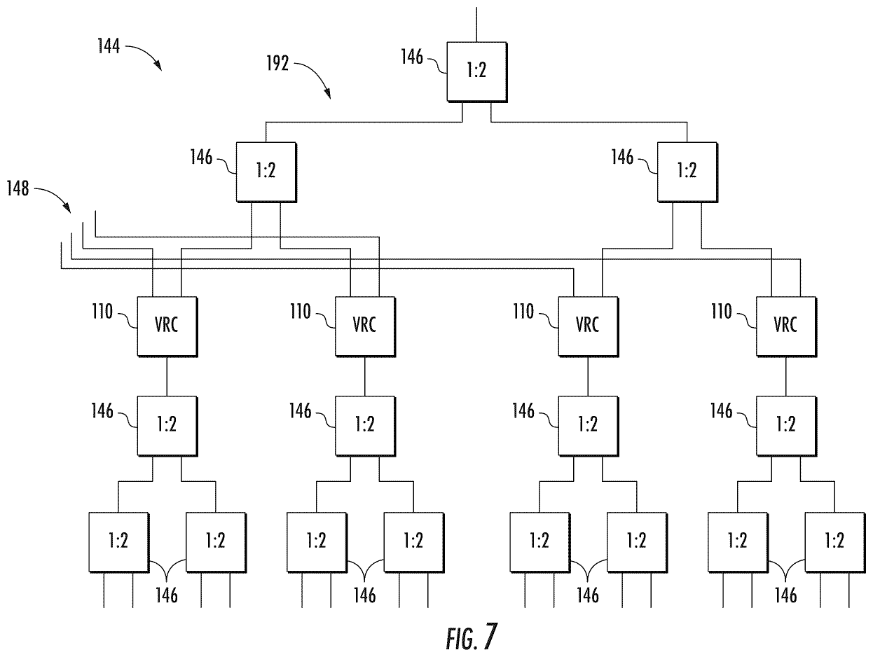

FIG. 7 illustrates another example network 144 that employs the use of VRC devices 184. The example network 144 has a plurality of levels, with the VRC devices 110 defining a single layer of the network 144 while splitters 146 that split an optical signal into two substantially equal split optical signals define the remaining layers of the network 144. The VRC devices 184 of the network 144 can be remotely controlled by alternate communication paths 148 provided as inputs to the VRC devices 184.

For example, the remotely controllable VRC devices 184 can be switched in case of a catastrophic event that takes out part of the network 114. Thus, the VRC devices 184 can reroute network traffic as needed.

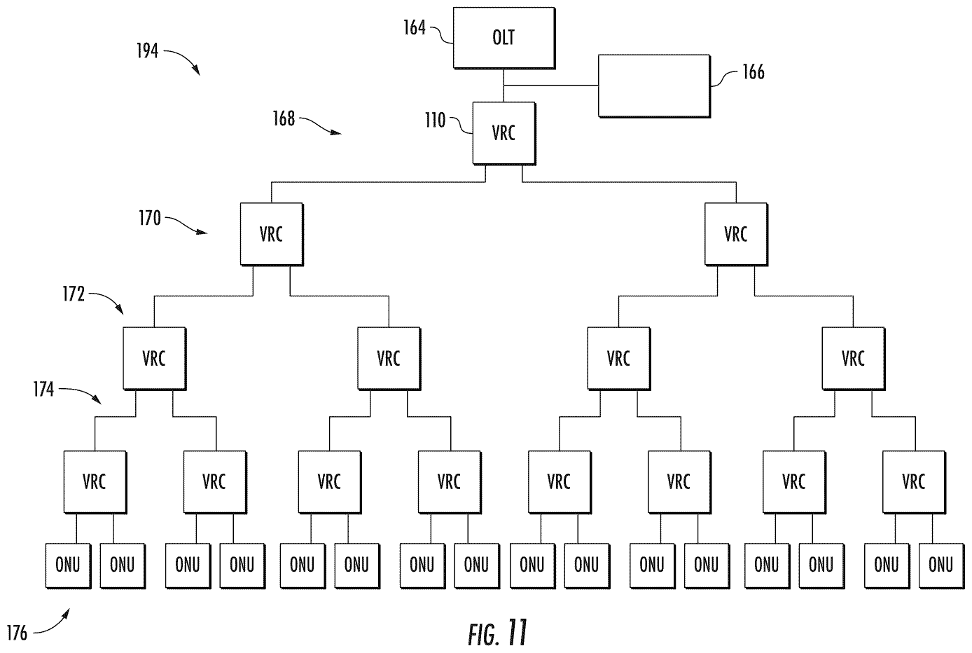

Alternatively, optical control signals may be multiplexed in time, to enable a control system to communicate with one or all of the VRC devices of the network. Time-division multiplexing (TDM) allows a master controller (see the control system 166 of FIG. 11) to control multiple VRC devices across a single fiber and a single wavelength by reserving time slots in a data stream and allocating them to a unique VRC device.

Alternatively, optical control signals may be incorporated into an envelope modulation of the optical communication signal, to enable a control system to communicate with one or all of the VRC devices of the network. Envelop modulation allows a master controller (see the control system 166 of FIG. 11) to control multiple VRC devices across a single fiber using the communication channel itself by encoding control signals into an envelope modulation of the data stream and allocating them to a unique VRC device.

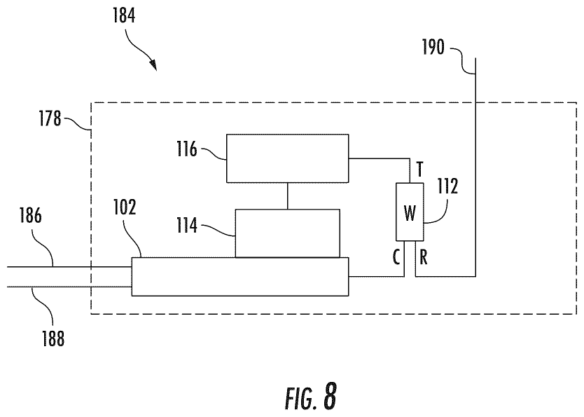

In the example of FIG. 7, the VRC devices 184 are oriented in the reverse orientation compared to the VRC device 110 shown in FIG. 2. Referring now to FIG. 8, an example VRC device 184 for the network 144 of FIG. 7 is illustrated. Like the VRC device 110 shown in FIG. 2, the example VRC device 184 of FIG. 8 includes a housing 178, a VRC 102, an actuator 114, a controller 116, and a WDM filter 112. Rather than a single input, the VRC device 184 of FIG. 8 has two inputs in the form of a main input 186 that is coupled to the main network route and an alternate input 188 that is coupled to one of the alternate communication paths 148 as shown in FIG. 7. A single output 190 of the VRC device 184 is coupled to an input of a downstream splitter 146. The output of the VRC 102 is coupled to the common port C of the WDM filter 112. The transmit port T of the WDM filter 112 is coupled to the controller 116, and the reflect port R of the WDM filter 112 is coupled to the output 190 of the VRC device 184. An optical control signal inputted by either the main input 186 or the alternate input 188 is filtered by the WDM filter 112 and provided to the controller 116 as described above.

Referring once again to FIG. 7, network traffic may be distributed through the main communication path 192 while the alternate communication path 148 may be used for only providing the optical control signals to the VRC devices 184. Alternatively, both the network traffic and optical control signals may be routed through the main communication path 192 while the alternate communication path 148 remains dormant until activation is required, such as due to a network failure.

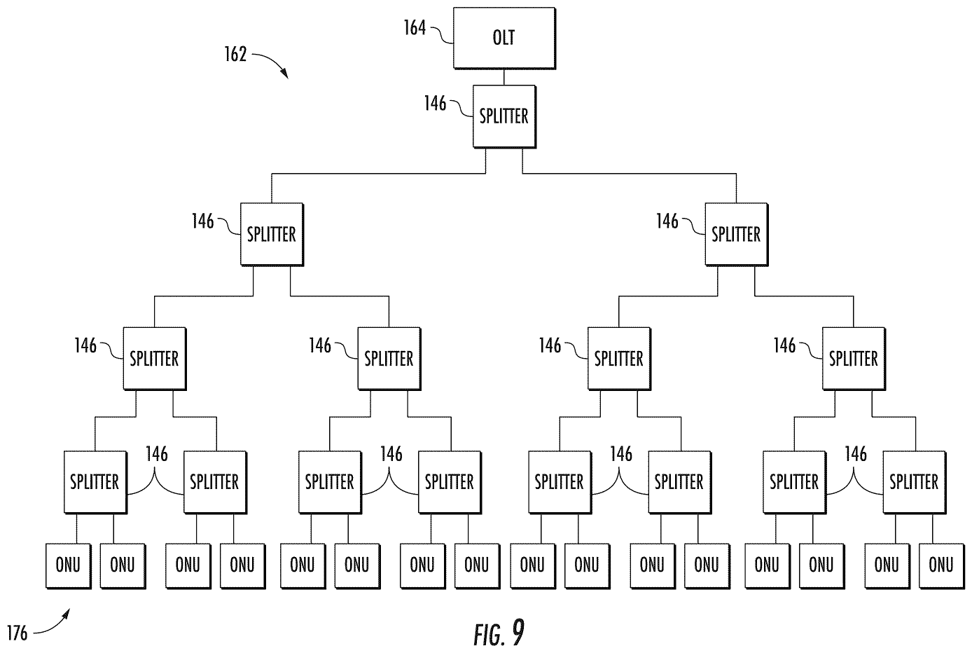

FIG. 9 illustrates a passive network 162 containing a central office in the form of an optical line termination (OLT) 164 and multiple customers having ONUs 176. The OLT 164 and the ONUs 176 are connected a network that may contain nodes and splitters 146 that connect other ONUs 176, but there is only one direction connection between the OLT 164 and each individual ONU 176.

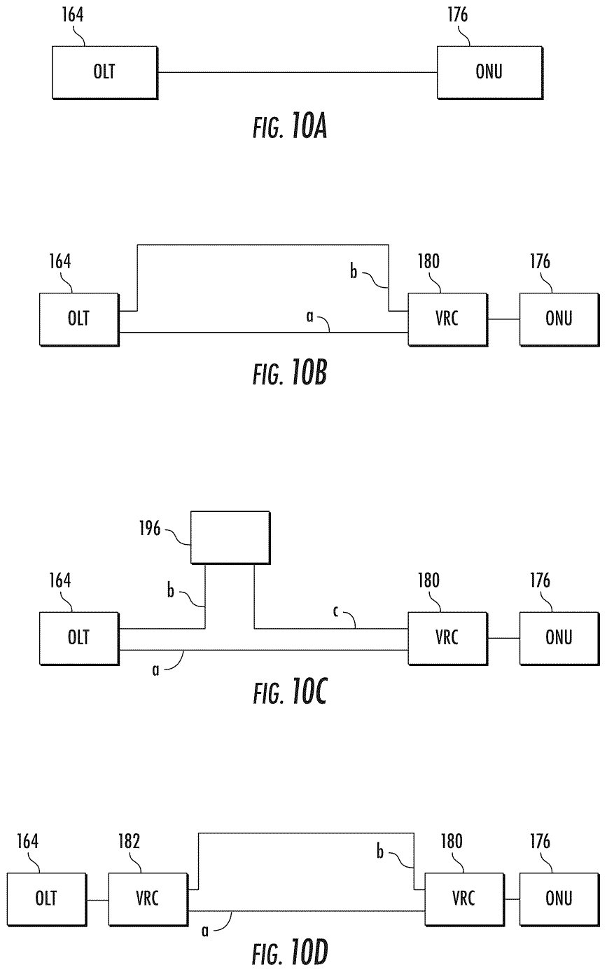

As the network 162 is static (i.e., the splitters 146 are fixed), the connection between the OLT 164 and any ONU may be simplified as a direct link as shown in FIG. 10A. Should any part of the network 162 between the OLT 164 and the ONU 176 be damaged or interrupted (e.g., though a natural disaster), there is no other way for affected ONUs 176 to communicate with the OLT 164. In this case, a reconfiguration of the transmitter or receiver cannot mitigate the situation. In some embodiments of the present disclosure, VRC devices 110 are employed to provide alternative communication paths between the ONUs 176 and the OLT 164.

FIGS. 10B-10D show example simplified networks having a direct alternative path either directly between A and C or through a node B. FIG. 10B illustrates that the ONU 176 has an ONU VRC 180. The ONU 176 and the ONU VRC 180 may be maintained within the same housing or separate components. The ONU VRC 180 provides a direct communication path through alternative line B. If communication through the direct line A is interrupted, the ONU 176 can instruct or otherwise trigger the ONU VRC 180 to switch to the alternative line B. This configuration does require a doubling of the transmitting equipment at the OLT 164. While the extra transmitting equipment does not need to be permanently in a transmit mode, it should be capable of turning on as soon as the communication between the OLT 164 and the ONU 176 is interrupted on the direct line A. After the direct line A is available again, the OLT 164 can instruct the ONU 176 to instruct or otherwise trigger the ONU VRC 180 to switch back to the original state.

FIG. 10C illustrates a configuration similar to that of FIG. 10B but includes a node 196 that is connected to the OLT 164 by a line B that may provide a shorter alternate line C to the ONU 176. In this case, the alternate equipment is already available at the OLT 164, so that only the network traffic has to be switched to the alternate route.

In the configuration of FIG. 10D, the doubling of the equipment at the OLT 164 is avoided by using an additional OLT VRC 182 that also switches to the alternate line B in case of a breakdown of communication between OLT 164 and the ONU 176. This is referred to as a Bridge and Select configuration.

Real-time configurability of VRC devices allows optimization of the network beyond the configuration of the transceivers. For example, the configurability of VRC devices allows for prioritization of selected network paths based on customer demand, network traffic, and external circumstances (e.g., line interruptions), performance improvement for selected customers, performance improvement for all customers (reduction of overall margins), increasing the number of customers beyond the capacity of static networks, and increasing network reach (i.e., the distance between central office and the customer) beyond the capacity of static networks.

FIG. 11 illustrates a network 194 comprising a central office in the form of an OLT 164 and multiple customers having optical network units VRC device 150. The network 162 is a branching optical network having a first level 168, a second level 170, a third level 172, and a fourth level 174 of VRC devices 110. The fourth level 174 of the VRC devices terminate at a plurality of ONUs 176 at customer locations.

The network 194 further includes a control system 166 that evaluates the status of all of the ONUs 176 within the network 194 and compares them to a desired state. The control system 166 can observe the operational parameters of the ONUs based on the optical signals propagating within the network 194 between the OLT 164 and the ONUs 176. Here, the VRC devices 110 are not directly controlled by a particular OLT 164 or ONU 176 but rather through the central control system 166 that controls the parameters of the OLT 164, the ONUs 176 and the VRC devices 110. The control system 166 may be used to (a) improve or prioritize particular paths of the network, (b) improve the performance for a subset of ONUs 176, (c) improve the performance for all ONUs 176, (d) support a larger number of ONUs 176, and (e) support ONUs 176 over larger distances.

In contrast to other technologies, one property of the VRC 102 is that it may be operated as open loop systems as their response is well characterized and directly determined by their inputs. However, it is also possible to add a feedback system for closed loop operation. The monitoring capability may also be utilized by the network control system 166.

Regarding case (a) above, the control system 166 and VRC devices 110 may be used to reroute network traffic depending on network conditions (e.g., disaster recovery). The control system 166 may be used to constantly monitor the network 194 and the availability of alternate routes, so it may not need to be available for all ONUs 176. While the occurrence may be sporadic, a fast response (in the range of milliseconds) is beneficial to avoid lengthy network outages.

Case (b) above refers to the delivery of premium services to selected customers (e.g., higher line speeds). This may be implemented infrequently in dynamic networks (residential areas) but may also change during the day (e.g., in public spaces, depending on traffic and frequency of people, e.g., train stations, airports, sporting events, conferences, etc.). The desired response time is expected to be on the scale of minutes. While some improvement may be delivered by adjusting the parameters of the OLT and ONUs, the ability to adjust the network 194 by way of the control system 166 delivers additional benefit by allowing power distribution in the network 194 to be optimized.

Cases (c), (d), and (e) are based on the optimization of the total margin in the network 194 through balancing surplus margin. Any excess margin is redistributed by adjusting the split ratios between the existing ONUs 176 to improve service (e.g., through offering higher speeds, case (c)), to add additional subscriber ONUs 176 to the network 194, or to extend the reach of the network 194 (connect ONUs 176 in larger distances).

While some improvement may be delivered by adjusting the parameters of the OLT 164 and ONUs 176, further optimization of the network performance/capacity may result from adjustable splitters.

In large and or complex networks, a significant number of different control channels and different VRC devices may be needed. This may make deployment and maintenance of the network difficult. As an alternative to configuration by optical control signals, VRC devices may be controlled remotely by using wireless control signals.

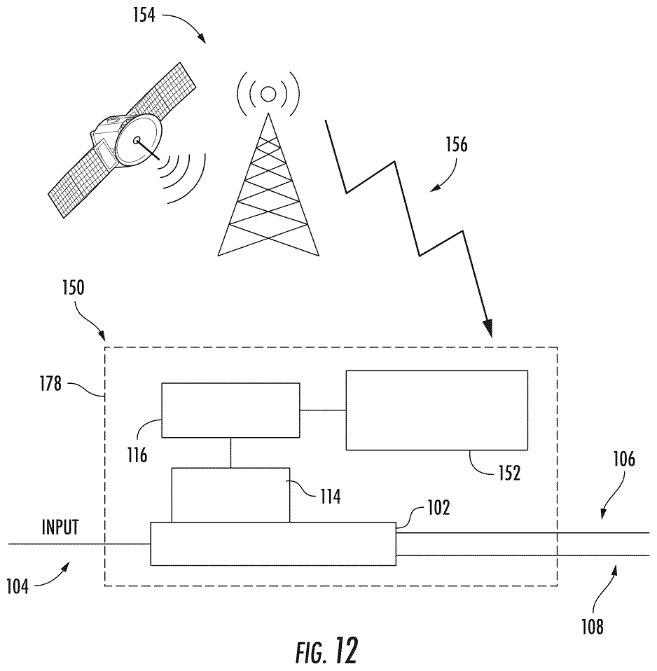

Referring now to FIG. 12, an example VRC device 150 capable of being controlled by a wireless control signal 156 is illustrated. Like the previously described VRC device 110, the example VRC device 150 includes a VRC 102, an actuator 114, a controller 116, an input 104, a main output 106, and a branch output 108. Rather than a WDM filter, the VRC device 150 includes a wireless communication receiver 152 that is capable of receiving a wireless control signal 156 from a wireless network communication device 154. The wireless network communication device 154 may be any device capable of producing the wireless control signal 156, such as a cellular tower, long-range internet-of-things (IoT) communication devices (e.g., LoRaWAN communication devices), and short-range wireless communication devices (e.g., Bluetooth® communication devices). The wireless control signal 156 provides data that is interpreted by the wireless communication receiver 152 (e.g., a cellular network antenna) to decipher the desired split ratio for the VRC device 150, which is then provided to the controller 116. Alternatives to LoRaWAN include NB-IOT or LTE-M.

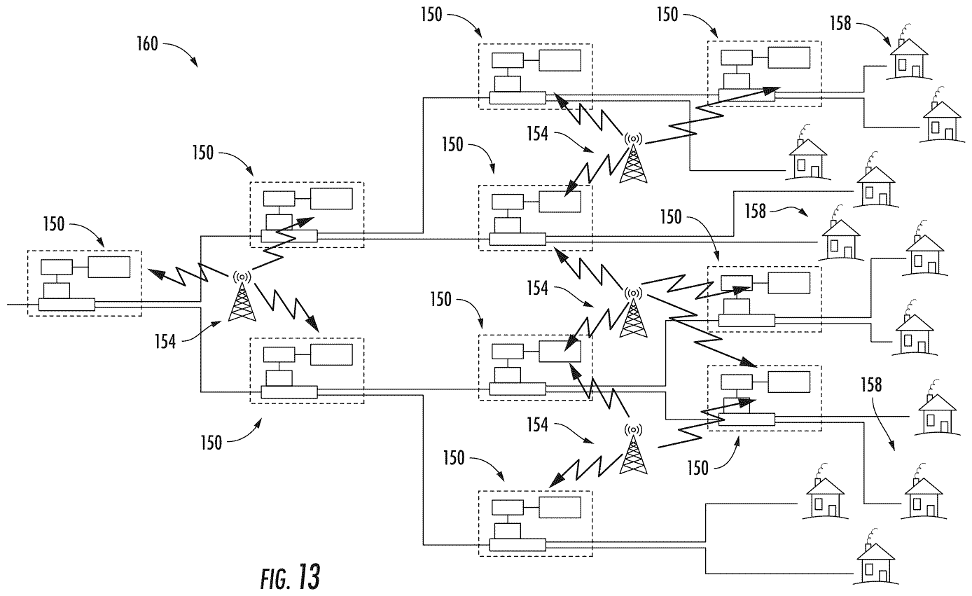

FIG. 13 illustrates a network 160 that includes a plurality of wireless network communication devices 154 configured as cellular towers that provide wireless control signals to control the split ratios of the VRC devices 150 within the network 160. However, as cellular towers may be part of a fiber-based network themselves, any event impacting all or part of the network 160 may also impact the ability to control the VRC devices 150. As an alternative, the wireless network communication devices 154 may be satellites, such as low-Earth orbit satellites or geostationary satellites, which would not be impacted by any disruption in the fiber-based network 160.

It should not be understood that embodiments of the present disclosure are directed to VRC devices and networks incorporating the same that provide for remote control of split ratios, and dynamic adjustment of a network for optimal performance and to mitigate network issues, such as those issues due to natural disasters. Thus, embodiments of the present disclosure allow performance optimization of the network, the delivery of premium services under varying network conditions to privileged customers, and fault recovery. The VRC devices described herein may be remotely controlled by optical control signals or by wireless control signals. The optical control signals may be provided by WDM or TDM.

In some embodiments, a master control system that monitors the state of the network can control the settings of all splitters in the network. Thus, network performance can be optimized for specific target users based on the current status of data demand, network conditions, and the like.

As used herein, the singular forms “a,” “an” and “the” include plural referents unless the context clearly dictates otherwise. Thus, for example, reference to “a” component includes aspects having two or more such components unless the context clearly indicates otherwise.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. An optical network comprising a plurality of variable ratio coupler (VRC) devices, wherein:
each VRC device comprises:
an input, a main output, and a branch output;
a VRC coupled to the input, the main output and the branch output;
an actuator operable to control the VRC to vary a split ratio of the VRC;
a wavelength division multiplex (WDM) filter positioned within the branch output and comprising a common port, a transmit port and a reflect port, the WDM filter operable to receive an optical signal at the common port and further operable to pass an optical control signal having a control wavelength at the transmit port and a filtered optical signal at the reflect port; and
a controller operable to receive the optical control signal having the control wavelength from the WDM filter and control the actuator to manipulate the VRC to have a split ratio based upon the optical control signal; and
the input, the main output and the branch output of the plurality of VRC devices are coupled such that the plurality of VRC devices is arranged in a branching network having a plurality of levels.

2. The optical network of claim 1, wherein the control wavelength of each VRC device is one of a plurality of control wavelengths.

3. The optical network of claim 2, wherein a number of VRC devices of the plurality of VRC devices is greater than a number of control wavelengths of the plurality of control wavelengths.

4. The optical network of claim 3, wherein individual VRC devices of the plurality of VRC devices are arranged within the branching network such that each individual VRC device is operable to receive an optical control signal at a particular control wavelength within an optical signal propagating within the optical network.

5. The optical network of claim 3, wherein the plurality of control wavelengths comprises four control wavelengths.

6. The optical network of claim 1, wherein:
the plurality of levels comprises a first level, a second level, a third level, and a fourth level;
the first level comprises one VRC device;
the second level comprises two VRC devices;
the third level comprises four VRC devices; and
the fourth level comprises eight VRC devices.

7. The optical network of claim 1, wherein VRC devices of a lowest level of the branching network are coupled to one or more subscribers.

8. A variable ratio coupler (VRC) device comprising:
a housing;
a VRC within the housing and comprising an input, a main output and a branch output;
an actuator within the housing operable to control the VRC to vary a split ratio of the VRC;
at least one wavelength division multiplex (WDM) filter within the housing comprising a common port, a transmit port, and a reflect port, wherein the at least one WDM filter operable to receive an optical signal at the common port and further operable to pass an optical control signal having a control wavelength at the transmit port and a filtered optical signal at the reflect port; and
a controller within the housing operable to receive the optical control signal having the control wavelength provided by the at least one WDM filter and control the actuator to manipulate the VRC to have a split ratio based upon the optical control signal.

9. The VRC device of claim 8, wherein:
the at least one WDM filter consists of a single WDM filter;
the WDM filter is operable to pass the optical control signal having the control wavelength at the transmit port and a filtered optical signal at the reflect port; and
the controller is operable to receive the control wavelength from the WDM filter.

10. The VRC device of claim 9, wherein the WDM filter is within the branch output.

11. The VRC device of claim 8, wherein the at least one WDM filter comprises a first WDM filter, a second WDM filter, and a splitter tap.

12. The VRC device of claim 11, wherein the VRC device is operable to pass a portion of the optical control signal having the control wavelength at the main output.

13. The VRC device of claim 11, wherein:
the splitter tap comprises an input port, a first output and a second output;
the transmit port of the first WDM filter is coupled to the input port of the splitter tap;
the first output of the splitter tap is coupled to the controller such that the controller receives a first portion the optical control signal from the first WDM filter and the splitter tap;
the second output of the splitter tap is coupled to the transmit port of the second WDM filter;
the common port of the second WDM filter is coupled to the input of the VRC;
the reflect port of the first WDM filter is coupled to the reflect port of the second WDM filter such that a filtered optical signal is provided to the second WDM filter; and
a second portion of the optical control signal and the filtered optical signal are provided to the input of the VRC through the common port of the second WDM filter.

14. An optical network comprising a plurality of variable ratio coupler (VRC) devices and a plurality of splitters, wherein:
each splitter comprises a splitter input and two splitter outputs;
each VRC device comprising:
an output, a main input, and an alternate input;
a VRC coupled to the output, the main input and the alternate input;
an actuator operable to control the VRC to vary a split ratio of the VRC;
a wavelength division multiplex (WDM) filter positioned within the output and comprising a common port, a transmit port and a reflect port, the WDM filter operable to receive an optical signal at the common port and further operable to pass an optical control signal having a control wavelength at the transmit port and a filtered optical signal at the reflect port; and
a controller operable to receive the optical control signal having the control wavelength from the WDM filter and control the actuator to manipulate the VRC to a split ratio corresponding with the control wavelength;
the optical network is a branching optical network having a plurality of levels;
the plurality of VRCs is within an individual level of the plurality of levels; and
each VRC device is coupled to an individual splitter output of the two splitter outputs of a preceding splitter at the main input and an alternate route optical fiber at the alternate input.

15. The optical network of claim 14, wherein the plurality of VRCs is within a third level of the plurality of levels.

16. The optical network of claim 14, wherein the optical control signal is received at the alternate input and an optical signal for communication is received at the main input for each VRC device.

17. The optical network of claim 14, wherein the optical control signal is capable of being received at both the alternate input and the main input for each VRC device.

18. An optical network comprising a plurality of variable ratio coupler (VRC) devices and a plurality of optical network units (ONU), wherein:
each VRC device comprises:
an input, a main output, and a branch output;
a VRC coupled to the input, the main output and the branch output;
an actuator operable to control the VRC to vary a split ratio of the VRC;
a controller operable to receive a control signal and control the actuator to manipulate the VRC to a split ratio corresponding with the control signal;
the input, the main output and the branch output of the plurality of VRC devices are coupled such that the plurality of VRC devices is arranged in a branching network having a plurality of levels;
the plurality of ONUs is at a lowest level of the plurality of levels; and
each ONU of the plurality of ONUs comprises an ONU VRC such that an ONU input of the ONU VRC is coupled to downstream components of the optical network toward a subscriber, a main ONU output of the ONU VRC is coupled to a preceding VRC device in the optical network, and a branch ONU output of the ONU VRC is coupled to an alternate communication path.

19. The optical network of claim 18, further comprising an optical line termination (OLT) device, wherein the alternate communication path couples the OLT device to the ONU VRC of an individual ONU.

20. The optical network of claim 19, further comprising at least one node coupled to the OLT device and the ONU VRC of at least one ONU.

21. The optical network of claim 19, wherein the OLT device comprises at least one OLT VRC coupled to the main ONU output and the branch ONU output of at least one ONU, and the at least one OLT VRC is operable switch to the alternate communication path.

22. The optical network of claim 18, further comprising a control system operable to monitor network traffic on the optical network and adjust one or more split ratios of the plurality of VRCs.

23. A variable ratio coupler (VRC) device comprising:
a housing;
a VRC within the housing and comprising an input, a main output and a branch output;
an actuator within the housing operable to control the VRC to vary a split ratio of the VRC;
a wireless communication receiver operable to receive a wireless control signal providing a split ratio; and
a controller operable to receive a signal corresponding to the wireless control signal from the wireless communication receiver and control the actuator to manipulate the VRC to the split ratio corresponding with the wireless control signal.

24. The VRC device of claim 23, wherein the wireless communication receiver is operable to receive a cellular wireless control signal.

25. The VRC device of claim 23, wherein the wireless communication receiver is operable to receive a satellite wireless control signal.
